(19) United States
(12) Patent Application Publication
(10) Pub. No.: US 2025/0299056 A1
(43) Pub. Date: Sep. 25, 2025

(54) PROMPT SESSION OPTIMIZATION

(71) Applicant: INTERNATIONAL BUSINESS MACHINES CORPORATION, ARMONK, NY (US)

(72) Inventors: Yi Shan Jiang, Bejing (CN); Ling Zhuo, Beijing (CN); Hong Wei Jia, Beijing (CN); Yun Wang, BeiJing (CN); He Sheng Yang, Beijing (CN)

(21) Appl. No.: 18/613,095

(22) Filed: Mar. 21, 2024

(51) Int. Cl. G06N 3/092

(52) U.S. Cl. CPC G06N 3/092

(57) ABSTRACT

A machine learning model (“MLM”) is set to a first temperature state, a baseline prompt is issued to the MLM at the first temperature state, and a first response to the baseline prompt is received from the MLM at the first temperature state. The MLM is set to a second temperature state, the baseline prompt is issued to the MLM at the second temperature state, and a second response to the baseline prompt is received from the MLM at the second temperature state. A selected baseline response (“SBR”) is selected from the first and second responses to the baseline prompt. The SBR is supplied as a baseline action to a reinforcement learning model (“RLM”) that is configured to compute a reward in response to the baseline action and to compute a predicted temperature state based on the reward.

### BACKGROUND

### Technical Field

The present disclosure generally relates to optimizing prompt sessions with machine learning models (“MLMs”), and more particularly but not by way of limitation, to accurately and reliably receiving responses to prompt queries with a desired extent of linguistic determinism by applying reinforcement learning during a prompt session to tune the MLM temperature.

### Description of the Related Art

MLMs such as large language models have revolutionized natural language processing by generating coherent and contextually relevant text responses to users' prompts. One important parameter in this field is understanding and control of the MLM's temperature parameter. The temperature plays a fundamental role in controlling the randomness and creativity of the generated output. Temperature determines the extent to which the MLM explores alternative word choices, thereby introducing variability in its responses to user prompts.

### SUMMARY

According to one embodiment, a computer-implemented method is provided for optimizing a prompt session with a machine learning model (“MLM”) trained on a training dataset. The computer-implemented method includes setting the MLM to a first temperature state, issuing a baseline prompt to the MLM at the first temperature state, and receiving a first response to the baseline prompt from the MLM at the first temperature state. The method also includes setting the MLM to a second temperature state, issuing the baseline prompt to the MLM at the second temperature state, and receiving a second response to the baseline prompt from the MLM at the second temperature state. A selected baseline response (“SBR”) is selected from the first and second responses to the baseline prompt. In some embodiments the SBP is supplied as a baseline action to a reinforcement learning model (“RLM”) that is configured to compute a reward in response to the baseline action and compute a predicted temperature state based on the reward.

In one embodiment, a computer program product is provided for optimizing a prompt session with a machine learning model (“MLM”) that is trained on a set of training data. The computer program product includes a computer readable storage medium having program instructions embodied therewith. The program instructions are executable by a processor to cause a computing device to set the MLM to a first temperature state, issue a baseline prompt to the MLM at the first temperature state, and receive a first response to the baseline prompt from the MLM at the first temperature state. The program instructions further cause the computing device to set the MLM to a second temperature state, issue the baseline prompt to the MLM at the second temperature state, and receive a second response to the baseline prompt from the MLM at the second temperature state. A selected baseline response (“SBR”) is selected from the first and second responses to the baseline prompt. In some embodiments the SBR is supplied as a baseline action to a reinforcement learning model (“RLM”) that is configured to compute a reward in response to the baseline action and compute a predicted temperature state based on the reward.

According to one embodiment, a computer system is provided for optimizing a prompt session with a machine learning model (“MLM”) that is trained on a set of training data. The computer system includes a processor, a computer-readable memory, a computer-readable tangible storage device, and program instructions stored on the computer-readable storage device for execution by a processor via the computer-readable memory, wherein the execution of the program instructions causes the computer system to perform a method. The method includes setting the MLM to a first temperature state, issuing a baseline prompt to the MLM at the first temperature state, and receiving a first response to the baseline prompt from the MLM at the first temperature state. The method also includes setting the MLM to a second temperature state, issuing the baseline prompt to the MLM at the second temperature state, and receiving a second response to the baseline prompt from the MLM at the second temperature state. A selected baseline response (“SBR”) is selected from the first and second responses to the baseline prompt. The SBR is supplied as a baseline action to a reinforcement learning model (“RLM”) that is configured to compute a reward in response to the baseline action and compute a predicted temperature state based on the reward.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a block depiction of a computer hardware platform including a prompt session optimization (“PSO”) engine for efficiently and reliably optimizing a prompt session with an MLM, consistent with illustrative embodiments.

FIG. 2 is a block depiction of a reinforcement learning computing system that includes the PSO engine of FIG. 1, consistent with illustrative embodiments.

FIG. 3 diagrammatically depicts similarity for multidimensional vectors in an embedding space of an MLM, consistent with illustrative embodiments.

FIG. 4 is a block depiction of workflow for encoding search vectors and data vectors to an MLM embedding space and for receiving responses to search vectors from the MLM embedding spacer, consistent with illustrative embodiments.

FIG. 5 is similar to FIG. 3 but depicts similarity for a search vector in relation to a plurality of data vectors embedded in an MLM embedding space, consistent with illustrative embodiments.

FIG. 6 is a three-dimensional depiction of three clusters of data vectors in an MLM embedding space, consistent with illustrative embodiments.

FIG. 7 depicts a high temperature response and a low temperature response to the prompt “what is the meaning of life?”, consistent with illustrative embodiments.

FIG. 8a depicts a comparatively low temperature sampling distribution of a sentence transformer encoder, consistent with illustrative embodiments.

FIG. 8b depicts a comparatively high temperature sampling distribution of the sentence transformer encoder of FIG. 8a, consistent with illustrative embodiments.

FIG. 9a diagrammatically depicts a search vector in the embedding space of FIG. 6 with the MLM temperature set to 0, consistent with illustrative embodiments.

FIG. 9b is similar to FIG. 9a but with the MLM temperature set less than 0.5.

FIG. 9c is similar to FIG. 9a but with the MLM temperature set greater than 0.5.

FIG. 10 is a flowchart depicting a method for prompt session optimization, consistent with illustrative embodiments.

FIG. 11 depicts an algorithm in the policy block of FIG. 10, consistent with illustrative embodiments.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

According to an aspect of the present disclosure, there is provided a computer-implemented method for optimizing a prompt session with a machine learning model (“MLM”) trained on a training dataset. The computer-implemented method includes setting the MLM to a first temperature state, issuing a baseline prompt to the MLM at the first temperature state, and receiving a first response to the baseline prompt from the MLM at the first temperature state. The computer-implemented method further includes setting the MLM to a second temperature state, issuing the baseline prompt to the MLM at the second temperature state, and receiving a second response to the baseline prompt from the MLM at the second temperature state. A baseline response (“SBR”) is selected from the first and second responses to the baseline prompt. The SBR is supplied as a baseline action to a reinforcement learning model (“RLM”) configured to compute a reward in response to the baseline action and compute a predicted temperature state based on the reward. A technical feature of the method is improved user experience during a prompt session by tuning the MLM for a desired linguistic determinism in the MLM's responses to the users prompts. A technical advantage of the method is improved temperature control without needing parametric knowledge of the temperature settings and associated sampling probability distributions.

In one embodiment, the method further sets the MLM to an iterative temperature state corresponding to a temperature state of the SBR, issues an iterative prompt to the MLM at the iterative temperature state, and receives a first response to the iterative prompt from the MLM at the iterative temperature state. The method further sets the MLM to the predicted temperature state, issues the iterative prompt to the MLM at the predicted temperature state, and receives a second response to the iterative prompt from the MLM at the predicted temperature state, A selected iterative response (“SIR”) is selected from the first and second responses to the iterative prompt. The method further determines if the SIR is satisfactory. A technical feature of the method is improved user experience during a prompt session by tuning the MLM for a desired linguistic determinism in the MLM's responses to the users prompts. A technical advantage of the method is improved temperature control without needing parametric knowledge of the temperature settings and associated sampling probability distributions. Another technical advantage of the method is improved processing capability and reduced processing overhead for the computing device.

In one embodiment, the method, upon determining that the SIR is satisfactory, sets the MLM to a temperature state corresponding to a temperature state of the SIR. Upon determining that the SIR is not satisfactory, the method supplies the SIR as an iterative action to the RLM that is configured to recompute the reward in response to the iterative action and recompute the predicted temperature state based on the recomputed reward. A technical feature of the method is improved user experience during a prompt session by tuning the MLM for a desired linguistic determinism in the MLM's responses to the users prompts. A technical advantage of the method is improved temperature control without needing parametric knowledge of the temperature settings and associated sampling probability distributions. Another technical advantage of the method is improved processing capability and reduced processing overhead for the computing device.

In one embodiment, the method further sets the MLM to a subsequent iterative temperature state corresponding to a temperature state of the SIR, issues a subsequent iterative prompt to the MLM at the subsequent iterative temperature state, and receives a first response to the subsequent iterative prompt from the MLM at the subsequent iterative temperature state. The method further sets the MLM to the recomputed predicted temperature state, issues the subsequent iterative prompt to the MLM at the recomputed predicted temperature state, and receives a second response to the subsequent iterative prompt from the MLM at the recomputed predicted temperature state. A subsequent SIR is selected from the first and second responses to the subsequent iterative prompt, and it is determined whether the subsequent SIR is satisfactory. A technical feature of the method is improved user experience during a prompt session by tuning the MLM for a desired linguistic determinism in the MLM's responses to the users prompts. A technical advantage of the method is improved temperature control without needing parametric knowledge of the temperature settings and associated sampling probability distributions. Another technical advantage of the method is improved processing capability and reduced processing overhead for the computing device.

In one embodiment, the method, upon determining that the subsequent SIR is satisfactory, sets the MLM to a temperature state corresponding to a temperature state of the subsequent SIR. Upon determining that the subsequent SIR is not satisfactory, the method supplies the subsequent SIR as a subsequent iterative action to the RLM that is configured to recompute the reward in response to the subsequent iterative action and recompute the predicted temperature state based on a most recent recomputed reward. A technical feature of the method is improved user experience during a prompt session by tuning the MLM for a desired linguistic determinism in the MLM's responses to the users prompts. A technical advantage of the method is improved temperature control without needing parametric knowledge of the temperature settings and associated sampling probability distributions. Another technical advantage of the method is improved processing capability and reduced processing overhead for the computing device.

In one embodiment, the training dataset includes a plurality of data vectors in an embedding space of the MLM. A technical feature of the method is improved user experience during a prompt session by tuning the MLM for a desired linguistic determinism in the MLM's responses to the users prompts. A technical advantage of the method is improved temperature control without needing parametric knowledge of the temperature settings and associated sampling probability distributions. Another technical advantage of the method is improved processing capability and reduced processing overhead for the computing device.

In one embodiment, the baseline prompt, the iterative prompt, and the subsequent iterative prompt each comprise a search vector in an embedding space of the MLM. A technical feature of the method is improved user experience during a prompt session by tuning the MLM for a desired linguistic determinism in the MLM's responses to the users prompts. A technical advantage of the method is improved temperature control without needing parametric knowledge of the temperature settings and associated sampling probability distributions. Another technical advantage of the method is improved processing capability and reduced processing overhead for the computing device.

In one embodiment, the iterative temperature state and the subsequent iterative temperature state each comprise a probability distribution around one of the search vectors in the embedding space of the MLM. A technical feature of the method is improved user experience during a prompt session by tuning the MLM for a desired linguistic determinism in the MLM's responses to the users prompts. A technical advantage of the method is improved temperature control without needing parametric knowledge of the temperature settings and associated sampling probability distributions. Another technical advantage of the method is improved processing capability and reduced processing overhead for the computing device. Another technical advantage of the method is improved processing capability and reduced processing overhead for the computing device.

In one embodiment, the iterative temperature state comprises a probability distribution around the SBR, and the subsequent iterative temperature state comprises a probability distribution around the SIR. A technical feature of the method is improved user experience during a prompt session by tuning the MLM for a desired linguistic determinism in the MLM's responses to the users prompts. A technical advantage of the method is improved temperature control without needing parametric knowledge of the temperature settings and associated sampling probability distributions. Another technical advantage of the method is improved processing capability and reduced processing overhead for the computing device. Another technical advantage of the method is improved processing capability and reduced processing overhead for the computing device.

According to an aspect of the present disclosure, a computer program product is provided for optimizing a prompt session with a machine learning model (“MLM”) that is trained on a set of training data. The computer program product includes a computer readable storage medium having program instructions embodied therewith. The program instructions are executable by a processor to cause a computing device to set the MLM to a first temperature state, issue a baseline prompt to the MLM at the first temperature state, and receive a first response to the baseline prompt from the MLM at the first temperature state. The program instructions further cause the computing device to set the MLM to a second temperature state, issue the baseline prompt to the MLM at the second temperature state, and receive a second response to the baseline prompt from the MLM at the second temperature state. A selected baseline response (“SBR”) is selected from the first and second responses to the baseline prompt. The SBR is supplied as a baseline action to a reinforcement learning model (“RLM”) configured to compute a reward in response to the baseline action and compute a predicted temperature state based on the reward. A technical feature of the method is improved user experience during a prompt session by tuning the MLM for a desired linguistic determinism in the MLM's responses to the users prompts. A technical advantage of the method is improved temperature control without needing parametric knowledge of the temperature settings and associated sampling probability distributions. Another technical advantage of the method is improved processing capability and reduced processing overhead for the computing device. Another technical advantage of the method is improved processing capability and reduced processing overhead for the computing device.

In one embodiment, the program instructions executable by the processor further cause the computing device to set the MLM to an iterative temperature state corresponding to a temperature state of the SBR, issue an iterative prompt to the MLM at the iterative temperature state, and receive a first response to the iterative prompt from the MLM at the iterative temperature state. The program instructions further cause the computing device to set the MLM to the predicted temperature state, issue the iterative prompt to the MLM at the predicted temperature state, and receive a second response to the iterative prompt from the MLM at the predicted temperature state. A selected iterative response (“SIR”) is selected from the first and second responses to the iterative prompt, a determination is made whether the SIR is satisfactory. A technical feature of the method is improved user experience during a prompt session by tuning the MLM for a desired linguistic determinism in the MLM's responses to the users prompts. A technical advantage of the method is improved temperature control without needing parametric knowledge of the temperature settings and associated sampling probability distributions.

In one embodiment, the program instructions executable by the processor further cause the computing device, upon determining that the SIR is satisfactory, to set the MLM to a temperature state corresponding to a temperature state of the SIR. Upon determining that the SIR is not satisfactory, the computing device supplies the SIR as an iterative action to the RLM that is configured to recompute the reward in response to the iterative action and recompute the predicted temperature state based on the recomputed reward. A technical advantage of the apparatus is improved processing capability and reduced processing overhead for the computing device.

In one embodiment, the program instructions executable by the processor further cause the computing device to set the MLM to a subsequent iterative temperature state corresponding to a temperature state of the SIR, issue a subsequent iterative prompt to the MLM at the subsequent iterative temperature state, and receive a first response to the subsequent iterative prompt from the MLM at the subsequent iterative temperature state. The computing device further sets the MLM to the recomputed predicted temperature state, issues the subsequent iterative prompt to the MLM at the recomputed predicted temperature state, and receives a second response to the subsequent iterative prompt from the MLM at the recomputed predicted temperature state. A subsequent SIR is selected from the first and second responses to the subsequent iterative prompt, and a determination is made whether the subsequent SIR is satisfactory. A technical feature of the method is improved user experience during a prompt session by tuning the MLM for a desired linguistic determinism in the MLM's responses to the users prompts. A technical advantage of the method is improved temperature control without needing parametric knowledge of the temperature settings and associated sampling probability distributions.

In one embodiment, the program instructions executable by the process further cause the computing device, upon determining that the subsequent SIR is satisfactory, to set the MLM to a temperature state corresponding to a temperature state of the subsequent SIR. Upon determining that the subsequent SIR is not satisfactory, the computing device supplies the subsequent SIR as a subsequent iterative action to the RLM that is configured to recompute the reward in response to the subsequent iterative action and recompute the predicted temperature state based on a most recent recomputed reward. A technical feature of the method is improved user experience during a prompt session by tuning the MLM for a desired linguistic determinism in the MLM's responses to the users prompts. A technical advantage of the method is improved temperature control without needing parametric knowledge of the temperature settings and associated sampling probability distributions.

In one embodiment, the training dataset includes a plurality of data vectors in an embedding space of the MLM. The baseline prompt, the iterative prompt, and the subsequent iterative prompt each include a search vector in an embedding space of the MLM. The iterative temperature state and the subsequent iterative temperature state each comprise a probability distribution around one of the search vectors in the embedding space of the MLM. A technical feature of the method is improved user experience during a prompt session by tuning the MLM for a desired linguistic determinism in the MLM's responses to the users prompts. A technical advantage of the method is improved temperature control without needing parametric knowledge of the temperature settings and associated sampling probability distributions.

According to an aspect of the present disclosure, there is provided a computer system for optimizing a prompt session with a machine learning model (“MLM”) that is trained on a set of training data. The computer system includes a processor, a computer-readable memory, a computer-readable tangible storage device, and program instructions stored on the storage device for execution by a processor via the computer-readable memory. The execution of the program instructions causes the computer system to perform a method, including setting the MLM to a first temperature state, issuing a baseline prompt to the MLM at the first temperature state, and receiving a first response to the baseline prompt from the MLM at the first temperature state. The method further includes setting the MLM to a second temperature state, issuing the baseline prompt to the MLM at the second temperature state, and receiving a second response to the baseline prompt from the MLM at the second temperature state. A selected baseline response (“SBR”) is selected from the first and second responses to the baseline prompt. The SBR is supplied as a baseline action to a reinforcement learning model (“RLM”) configured to compute a reward in response to the baseline action and compute a predicted temperature state based on the reward. A technical feature of the system is improved computer processing speed and reduced processing overhead by. A technical feature of the method is improved user experience during a prompt session by tuning the MLM for a desired linguistic determinism in the MLM's responses to the users prompts. A technical advantage of the method is improved temperature control without needing parametric knowledge of the temperature settings and associated sampling probability distributions.

In one embodiment, the system includes setting the MLM to an iterative temperature state corresponding to a temperature state of the SBR, issuing an iterative prompt to the MLM at the iterative temperature state, and receiving a first response to the iterative prompt from the MLM at the iterative temperature state. The system further sets the MLM to the predicted temperature state, issues the iterative prompt to the MLM at the predicted temperature state, and receives a second response to the iterative prompt from the MLM at the predicted temperature state. A selected iterative response (“SIR”) is selected from the first and second responses to the iterative prompt, and a determination is made whether the SIR is satisfactory. A technical feature of the method is improved user experience during a prompt session by tuning the MLM for a desired linguistic determinism in the MLM's responses to the users prompts. A technical advantage of the method is improved temperature control without needing parametric knowledge of the temperature settings and associated sampling probability distributions.

In one embodiment, the system, upon determining that the SIR is satisfactory, sets the MLM to a temperature state corresponding to a temperature state of the SIR. Upon determining that the SIR is not satisfactory, the system supplies the SIR as an iterative action to the RLM that is configured to recompute the reward in response to the iterative action and recompute the predicted temperature state based on the recomputed reward. The system sets the MLM to a subsequent iterative temperature state corresponding to a temperature state of the SIR, issues a subsequent iterative prompt to the MLM at the subsequent iterative temperature state, and receives a first response to the subsequent iterative prompt from the MLM at the subsequent iterative temperature state. The system further sets the MLM to the recomputed predicted temperature state, issues the subsequent iterative prompt to the MLM at the recomputed predicted temperature state, and receives a second response to the subsequent iterative prompt from the MLM at the recomputed predicted temperature state. A subsequent SIR is selected from the first and second responses to the subsequent iterative prompt. A determination is made whether the subsequent SIR is satisfactory. Upon determining that the subsequent SIR is satisfactory, the system further sets the MLM to a temperature state corresponding to a temperature state of the subsequent SIR. Upon determining that the subsequent SIR is not satisfactory, the system supplies the subsequent SIR as a subsequent iterative action to the RLM that is configured to recompute the reward in response to the subsequent iterative action and recompute the predicted temperature state based on a most recent recomputed reward. A technical advantage of the system is improved processing capability and reduced processing overhead for the computing device. A technical feature of the method is improved user experience during a prompt session by tuning the MLM for a desired linguistic determinism in the MLM's responses to the users prompts. A technical advantage of the method is improved temperature control without needing parametric knowledge of the temperature settings and associated sampling probability distributions.

Although the terms first, second, third, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It is to be understood that other embodiments can be used, and structural or logical changes can be made without departing from the spirit and scope defined by the claims. The description of the embodiments is not limiting. In particular, elements of the embodiments described hereinafter may be combined with elements of different embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

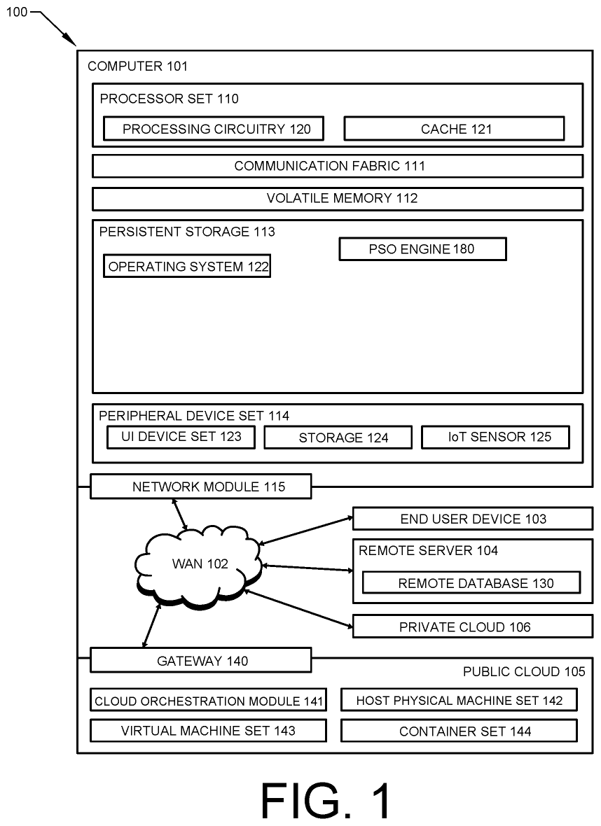

Referring to FIG. 1, environment 100 includes an example of an environment for the execution of at least some of the computer code involved in performing the inventive methods discussed herein, including a prompt session optimization (“PSO”) engine 180. In addition to the PSO engine 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and PSO engine 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the PSO engine 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in the PSO engine 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Accordingly, the computing system generally facilitates signal processing in accordance with one or more embodiments illustratively described herein. For example, the signal processing can be related to artificial neural network systems, an artificial intelligence system, a collaborative filtering system, a recommendation system, a signal processing system, a word embedding system, a topic model system, an image processing system, a data analysis system, a media content system, a video-streaming service system, an audio-streaming service system, an e-commerce system, a social network system, an internet search system, an online advertisement system, a medical system, an industrial system, a manufacturing system, and/or another digital system. The system can employ hardware and/or software to solve problems that are highly technical in nature, that are not abstract and that cannot be performed as a set of mental acts by a human.

For simplicity of explanation, the specialized-computer-implemented methods are depicted and described as a series of acts. It is to be understood and appreciated that the subject innovation is not limited by the acts illustrated and/or by the order of acts. That is, for example, acts can occur in various orders and/or concurrently, and with other acts not presented and described herein. Furthermore, not all expressly disclosed acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from a computer-readable device or storage media.

The system can employ hardware and/or software to solve problems that are highly technical in nature, that are not abstract and that cannot be performed as a set of mental acts by a human. One or more embodiments of the system can also provide technical improvements to a computer processing unit associated with control signal processing by improving processing performance of the computer processing unit, reducing computing errors and computing bottlenecks of the computer processing unit, improving processing efficiency of the computer processing unit, and/or reducing an amount of time for the computer processing unit to perform a computer process.

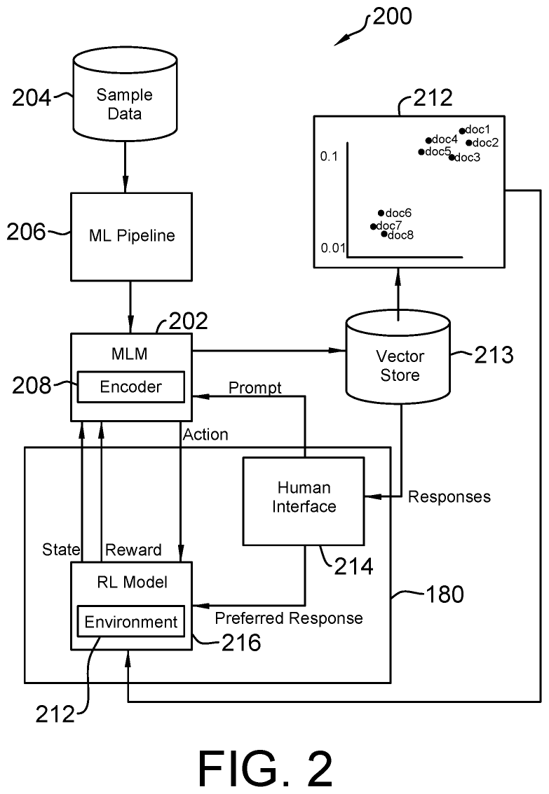

In this disclosure of illustrative embodiments, FIG. 2 diagrammatically depicts a reinforcement learning computing environment 200 in which the PSO engine 180 (FIG. 1) is configured to automatically guide a user in optimally tuning the temperature of a machine learning model (“MLM”) 202, such as but not limited to a foundation model or a large language model, during a prompt session with the MLM 202. Although the disclosed embodiments are directed to applying machine learning to natural language processing, alternative equivalent embodiments can be directed to other types of machine learning such as but not limited to those directed to image classification, computer vision, gaming, and the like.

The computing environment 200 can include collecting and conditioning datasets from sample data 204 stored in a computer memory. The quality of training the MLM 202 depends on the amount and quality of the sample data 204. A machine learning (“ML”) pipeline 206 can function on one end to parse training datasets from the stored sample data 204, such as for high-speed parallel training trials in any desired number of MLMs 202. On the other end, the ML pipeline 206 can function to supply the training datasets to high-speed parallel training trials running on one or more MLMs 202. In between, the data pipeline 206 can function to preprocess the data sets into proper form to run reliably on the MLM model(s) 202.

At the first end, the sample data 204 can be stored in one or multiple computer memories. Extracting datasets from the sample data 204 can involve many formatting operations, such as joining data tables together and the like. Preprocessing the data sets can involve many transformative operations, such as resizing images, decoding videos, augmenting data, and the like. The preprocessing can include multiplexing a feature data stream and a label data stream into a unified complex data stream to the training trials. In an example in which the features include video images, the labels can be cross-identifications for the images, and the like. This label processing can further include transforming integer values to tensor values for performing classification modeling. Duplicate data can be discarded, and incomplete or erroneous data can be supplemented and/or corrected. The sample data 204 can also be randomized before parsing it to reduce the adverse effects of sampling variations. The sample data 204 can also be divided into mutually exclusive portions. The largest portion is typically for a training dataset, whereas smaller portions can be used for a test dataset, a tuning dataset, and the like.

The MLM 202 can be any of a number of different machine models that can be used with machine learning. Generally, machine models well suited for natural language processing include bidirectional encoder representations from transformers (“BERT”) and generative pre-trained transformers (“GPT”). Other ML resources in the computing environment 200 can employ any suitable ML based techniques, statistical-based techniques and/or probabilistic-based techniques. For example, ML resources can employ expert systems, fuzzy logic, support vector machines (“SVMs”), hidden Markov models (HMMs), greedy search algorithms, rule-based systems, Bayesian models (e.g., Bayesian networks), neural networks, other non-linear training techniques, data fusion, utility-based analytical systems, and the like. For example, ML resources can perform a set of clustering ML computations, such as k nearest neighbors (“kNN”) and/or approximate nearest neighbors (“ANN”) computational blocks, a set of linear and/or logistic regression ML computations, a set of decision tree ML computations, a set of random forest ML computations, a set of regression tree ML computations, a set of least square ML computations, a set of instance-based ML computations, a set of support vector regression ML computations, a set of k-means ML computations, a set of spectral clustering ML computations, Gaussian mixture model ML computations, a set of regularization ML computations, a set of rule ML computations, a set of Bayesian ML computations, a set of deep Boltzmann computations, a set of deep belief network computations, a set of convolution neural network computations, a set of stacked auto-encoder computations and/or a set of different ML computations.

Hyperparameters of the MLM 202 can be tuned for optimized performance. One such hyperparameter is specifically addressed in this disclosure, that of the MLM 202 temperature. Other hyperparameters can be tuned as well including, for example, the number of hidden layers in a neural network, learning rate, and the like.

The MLM 202 can have an encoder 208 to convert the sample data 204 in many forms, such as documents, text, classifications and sub-classifications and the like, into data vectors in a Euclidean embedding space 212 of the MLM 202. The encoder 208 can include a number of sentence transformers that are configured to preserve the semantic content of the sample data 204 in the complex, multi-dimensional data vectors.

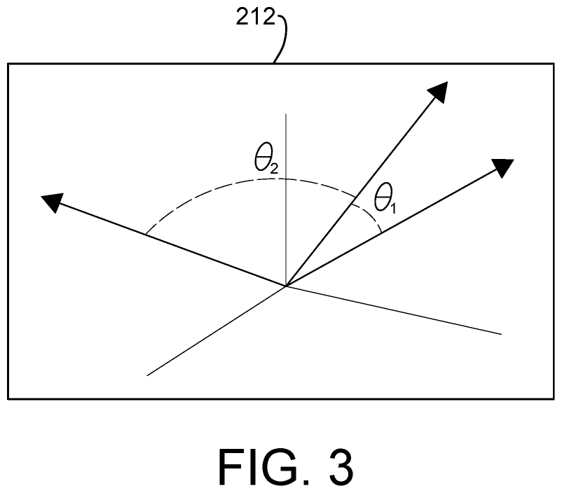

FIG. 2 depicts a simplified two-dimensional representation of several encoded data vectors in the embedding space 212. The closer together adjacent data vectors are in the embedding space 212, the more similar is the linguistic content of the documents they represent. For example, the vector embeddings indicate that the linguistic content of doc1 compared to doc2 is more similar than that of doc1 compared to doc8. FIG. 3 is a simplified depiction of different similarities between three vectors in a multidimensional embedding space 212. The similarity of two vectors is related to the inner product of the angle between them, which can be computed such as in terms of cosine similarity.

Returning to FIG. 2, groups of similar documents form data vector clusters. Particularly, in this example five data vectors form a first cluster (doc1, doc2, doc3, doc4, doc5) and three data vectors form a second cluster (doc6, doc7, doc8). Overall closeness, collectively, of all data vectors in a cluster defines a cluster density. That is, the first cluster (doc1-doc5) has a lower cluster density than the second cluster (doc6-doc8).

A vector store 213 can be used to identify, store, and retrieve the data vectors so they only have to be computed once for computations. This decreases the computational overhead and increases data throughput. The vector store 213 can also perform valuable resource functions such as computing distances between data vectors, approximate nearest neighbor (“ANN”) computations for data vectors, and the like. In more complex applications the vector store 213 can be a vector database, such as commercially available vector databases marketed under Pinecone® Weaviate®, Chroma®, and other brands. In less complex applications the vector store 213 can be a vector library, such as commercially available vector libraries marketed under FAISS®, ScaNN®, ANNOY®, and other brands.

The PSO engine 180 can include a human interface 214 with which a user can input prompts to query the MLM 202 for information. The PSO engine 180 can also include a reinforcement learning (“RL”) model 216, sometimes referred to as a reward model. In the context of reinforcement learning, the MLM 202 is sometimes referred to as the agent. The RL model 216 passes a reward and a state to the MLM 202, which in return passes an action back to the RL model 216. The state refers to a current configuration of the embedding space (or environment) 212. The reward provides feedback information from the embedding space 212 and is used to evaluate actions taken by the MLM 202. Generally, the RL model 216 generates a positive reward to inform the MLM 202 that it took an action that is in accordance with a desired goal of the RL model 216. Ultimately, the goal of the RL model 216 is to guide the MLM 202 in making actions that maximize the reward function.

Examples of RL model algorithms that can be used include a Markov decision process (MDP) such as is generally depicted in FIG. 2. Other RL approaches can include Monte Carlo methods, temporal difference learning, Q-learning, deep Q networks (DQN), state-action-reward-state-action (SARSA), a distributed cluster-based multi-agent bidding solution (DCMAB), and the like.

The computing environment 200 is thereby specifically configured to provide technical improvements to data systems, machine learning systems, artificial intelligence systems, and data analysis systems such as but not limited to data classification systems, data regression systems, data batching and clustering systems, and the like. The prompt session optimization of this disclosure can further provide one or more inferences, provide one or more predictions, and/or determine one or more relationships among the data. For example, optimization as described herein can model one or more inferences and/or predictions and/or may determine one or more relationships amongst the variables analyzed in the data. Machine learning predicts outputs, e.g., probabilities, from historical data. Such optimized machine learning helps with downstream decision making, even with such downstream decision making that is automated.

Accordingly, the computing environment 200 generally facilitates optimizing machine learning in accordance with one or more embodiments illustratively described herein. For example, the optimizations can be related to high-speed parallel training trial systems, an artificial intelligence system, a collaborative filtering system, a recommendation system, a signal processing system, a word embedding system, a topic model system, an image processing system, a data analysis system, a media content system, a video-streaming service system, an audio-streaming service system, an e-commerce system, a social network system, an internet search system, an online advertisement system, a medical system, an industrial system, a manufacturing system, and/or another digital system. The system can employ hardware and/or software to solve problems that are highly technical in nature, that are not abstract and that cannot be performed as a set of mental acts by a human.

For simplicity of explanation, the specialized-computer-implemented methods and computer program products are depicted and described as a series of acts. It is to be understood and appreciated that the subject innovation is not limited by the acts illustrated and/or by the order of acts. That is, for example, acts can occur in various orders and/or concurrently, and with other acts not presented and described herein. Furthermore, not all expressly disclosed acts are necessarily required to implement the computer-implemented methodologies and products in accordance with the disclosed subject matter. In addition, those skilled in the art will understand and appreciate that the computer-implemented methodologies and products could alternatively be represented as a series of interrelated states via a state diagram or events. Additionally, it should be further appreciated that the computer-implemented methodologies disclosed herein and throughout this specification are capable of being stored on an article of manufacture to facilitate transporting and transferring such computer-implemented methodologies to computers. The term article of manufacture, as used herein, is intended to encompass a computer program accessible from a computer-readable device or storage media.

The system can employ hardware and/or software to solve problems that are highly technical in nature, that are not abstract and that cannot be performed as a set of mental acts by a human. One or more embodiments of the system can also provide technical improvements to a computer processing unit associated with a ML process by improving processing performance of the computer processing unit, reducing computing bottlenecks of the computer processing unit, improving processing efficiency of the computer processing unit, and/or reducing an amount of time for the computer processing unit to perform the ML process.

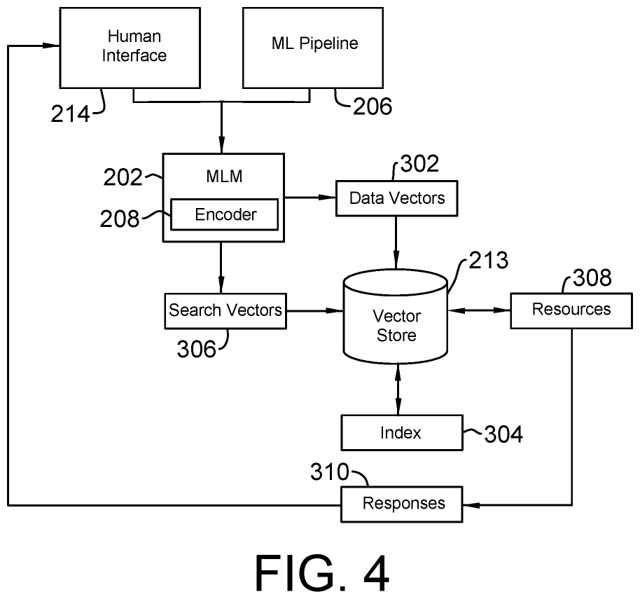

FIG. 4 is a high-level block depiction of a workflow in generating the vector embeddings and searching them. The ML pipeline 206 supplies to the MLM 202 pre-processed sample data 204 (FIG. 2) in many forms such as documents, text, categories and the like. The MLM 202 encodes the sample data 204 to generate data vectors 302 that can be identified in and referenced from an index 304. The index 304 is a data structure storing metadata for the data vectors 302 in a computer memory, such as in a random-access memory. In this way the vector store 213 is configured to enable fast, reliable, and low-overhead computations with the stored data vectors 302.

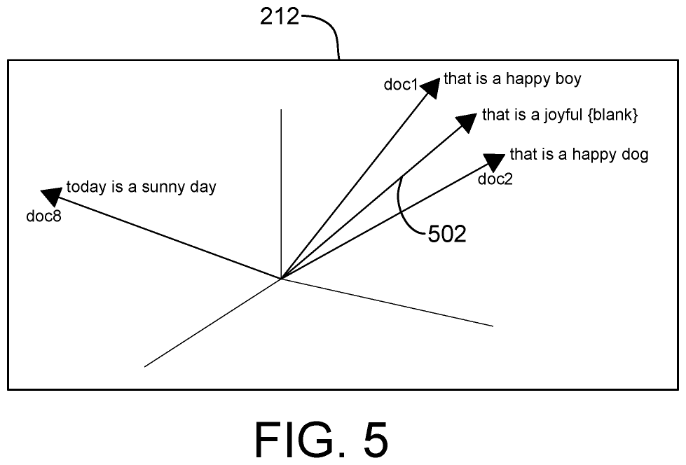

After the data vectors 302 are stored in the index 304, a user can input search prompts to query the MLM 202 via the human interface 214. The MLM 202 encodes the user's prompts into search vectors in a similar way it encodes the data vectors 302. The vector store 212 can thereafter execute search algorithms with the support of resources 308 stored in computer memory, such as computed vector distances, ANN values and the like, to generate responses 310 to the user's prompts. FIG. 5 is similar to FIG. 3, but further depicts the MLM 202 having encoded a user prompt “that is a joyful {blank}” to generate a search vector 502 in closer proximity to the first cluster of data vectors (doc1-doc5 in FIG. 2) than the second cluster of data vectors (doc6-doc8 in FIG. 2).

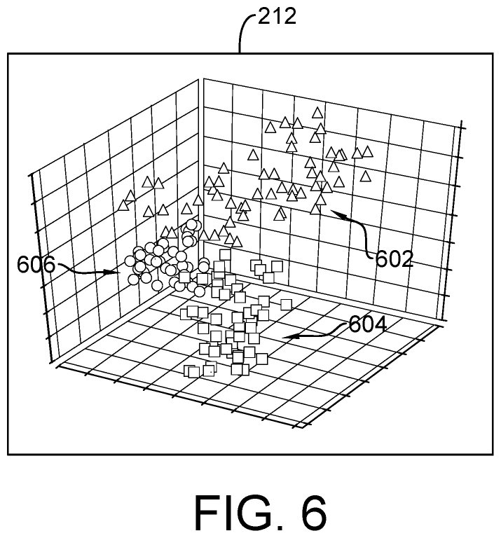

FIG. 6 is a more complex and realistic three-dimensional depiction of the embedding space 212 (FIG. 2) including three vector clusters 602, 604, 606 of data vectors each represented by triangles, squares, and circles, respectively. Dense packing of different clusters in the embedding space 212 such as this can bring into play the temperature hyperparameter of the MLM 202. Generally, the temperature value can be changed to alter the degree of linguistic determinism in the responses from the MLM 202 to user prompts. The temperature can generally be set to a desired value within a range from 0 to 1, and in some cases from 0 to 2. For furthering this discussion, the former range is used.

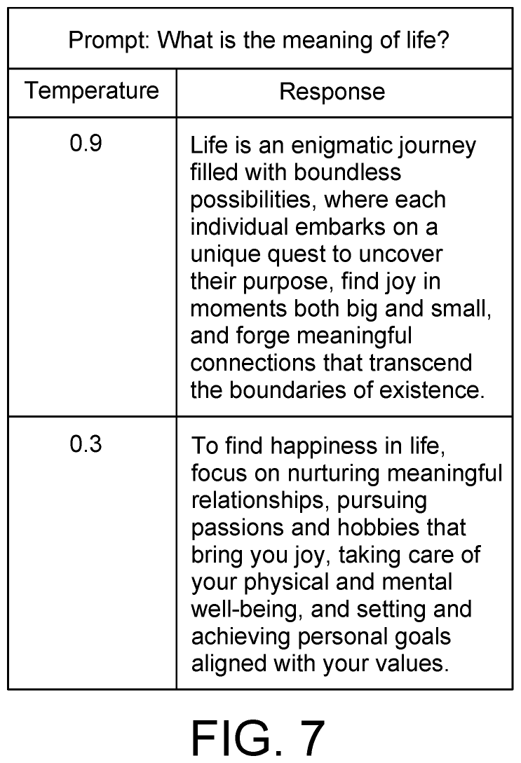

A high temperature setting generally results in lowering the deterministic nature of responses from the MLM 202, by making the responses more random and creative. This is preferred in use cases involving creative endeavors like story writing, poem writing, generating a title or a tag line, and the like. Conversely, a low temperature setting generally results in increasing the deterministic nature of responses from the MLM 202, by making the responses more predictable and reproducible. This is preferred in use cases involving more factual endeavors like answering questions, researching historical facts, writing technical instructions, and the like. FIG. 7 illustrates deterministically different responses from the MLM 202 in responses to the same user prompt “what is the meaning of life.” The less deterministic response was obtained at a high MLM temperature of 0.9, and the more deterministic response was obtained at a low MLM temperature of 0.3

Varying the MLM temperature results in altering the probability distribution of sampling in the embedding space 212 when the MLM 202 is encoding search vectors. In some embodiments, for example, the temperature parameter T alters the Softmax sampling function as an exponential denominator in the log function:

$$s ( {x}_{i} ) = \frac{{e}^{\frac{{x}_{i}}{T}}}{{\sum }_{i = 1}^{N} {e}^{\frac{{x}_{i}}{T}}}$$

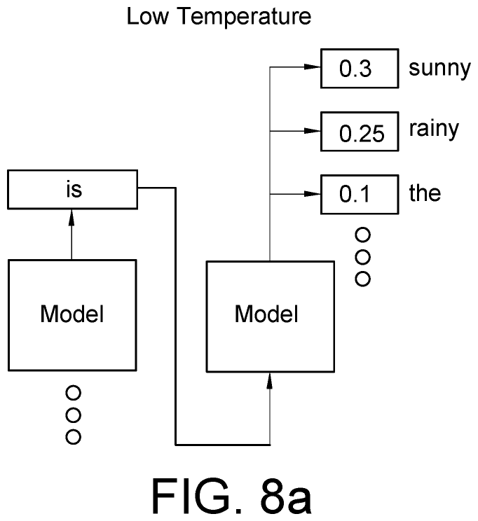

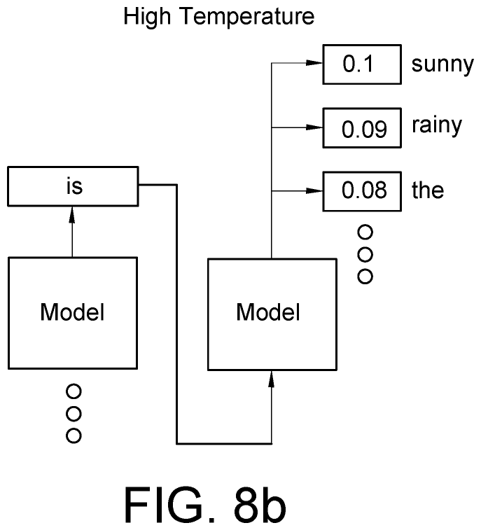

FIGS. 8a and 8b illustrate how this temperature-dependent function probabilistically affects the sampling distribution during vector encoding. In the low temperature setting of FIG. 8a, the probability of the MLM's sentence transformer selecting the highest token “sunny” for the next word is 30% and the second-highest token “rainy” is 5% lower. But at the high temperature setting in FIG. 8b, “sunny” is only a 10% probability and “rainy” is only 2% lower. Also, at the high temperature of FIG. 8b there will be more tokens in the sampling pool because ultimately, they all sum to 1.0.

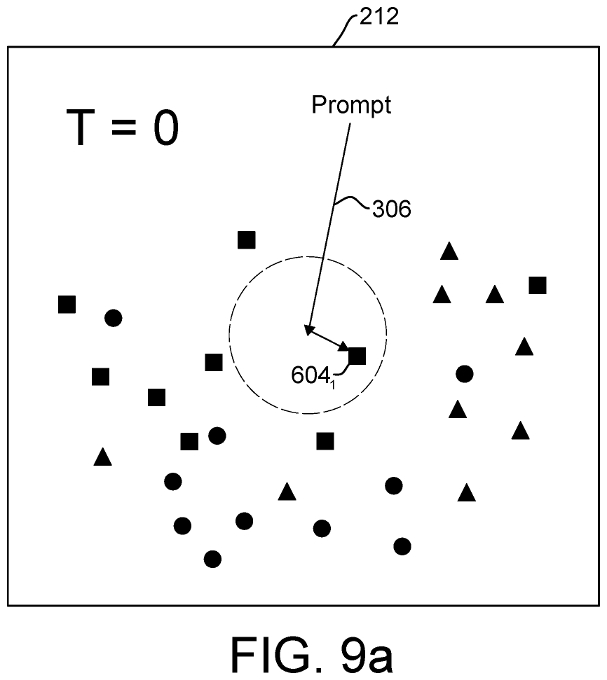

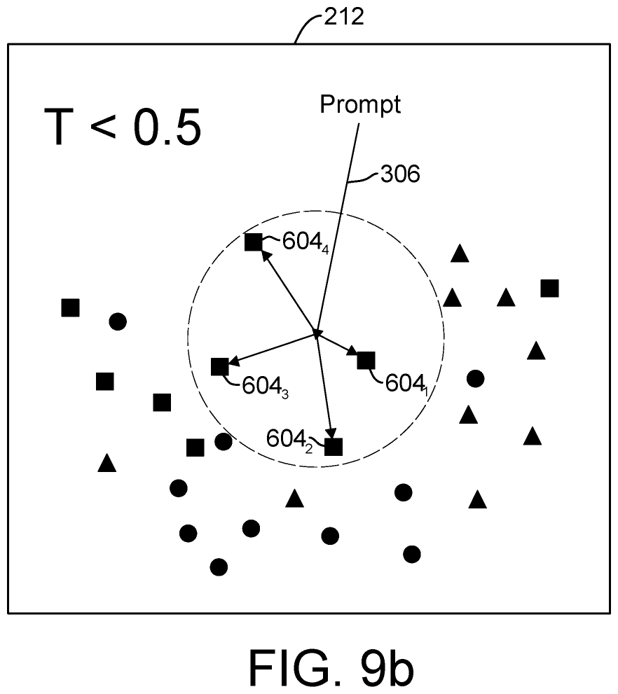

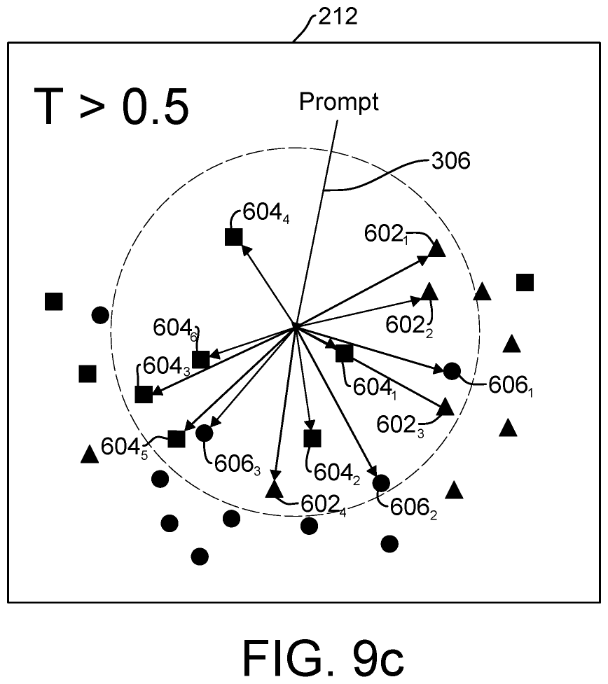

FIGS. 9a, 9b, 9c are simplified two-dimensional diagrams depicting a search vector 306 centered in a region of the embedding space 212 (FIG. 6) where the three vector clusters 602, 604, 606 are also embedded. These FIGS. illustrate the different probability samplings that result from setting the temperature value to zero in FIG. 9a, to a value less than 0.5 in FIG. 9b, and to a value greater than 0.5 in FIG. 9c. In reality, the probability distribution is spherical in the embedding space 212, but the two-dimensional illustrations in FIGS. 9a, 9b, 9c beneficially aid reader comprehension as to how the different temperature settings affect the sampling distributions.

The temperature setting of zero in FIG. 9a baselines this comparison in that typically it will result in sampling only the highest probability token, the nearest neighbor to the search vector 306, which in this example is data vector 604₁. Raising the temperature in FIG. 9b to a low temperature value, such as a value less than 0.5, increases the sampling distribution to include four data vectors 604₁, 604₂, 604₃, 604₄. In this example, all the data vectors within the sampling distribution of FIG. 9b are members of the same vector cluster 604. This renders the response less deterministic than in FIG. 9a, but only to the extent that the responses will be limited to the linguistic content of only one vector cluster 604. Raising the temperature in FIG. 9c to a high temperature value, such as a value greater than 0.5, increases the sampling distribution even more to include thirteen data vectors. In this example, the data vectors within the high-temperature sampling distribution of FIG. 9c include members of all three of the vector clusters 602₁-602₄, 604₁-604₆, 606₁-606₃. This renders the response comparatively even less deterministic, returning more creative responses.

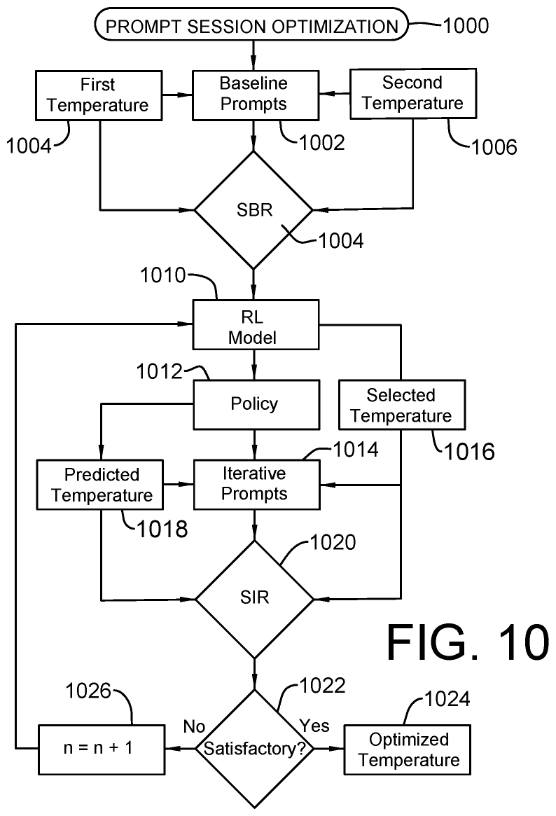

FIG. 10 is a flowchart depicting an illustrative inventive method 1000 for optimizing a prompt session with the MLM after it is trained on a training dataset. The method 1000 begins by block 1002 issuing a baseline prompt to the MLM at each of a first temperature state and a second temperature state. SBR block 1004 sets the MLM to the first temperature state. The baseline prompt is issued to the MLM at the first temperature state. A first response to the baseline prompt is received from the MLM at the first temperature state. Block 1006 sets the MLM to the second temperature state. The baseline prompt is issued to the MLM at the second temperature state. A second response to the baseline prompt is received from the MLM at the second temperature state.

SBR block 1004 selects a selected baseline response (“SBR”) from the first and second responses to the baseline prompt. The selection can be made by a human user via a computer interface, or the selection can be automatically performed. RL model block 1010 supplies the SBR as a baseline action to a reinforcement learning (“RL”) model.

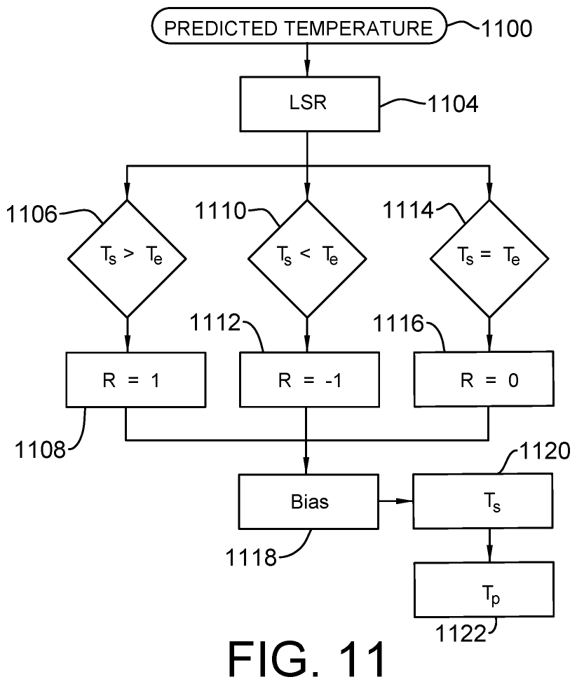

The RL model controls a policy block 1012 to compute a reward in response to the baseline action. A worthwhile goal of the RL model is to predict a temperature that is satisfactory to the user, and as easily and quickly as possible. Although any algorithm operating in accordance with that goal can be used, FIG. 11 depicts an illustrative computer method 1100 for computing a reward R in response to the baseline action, and for computing a predicted temperature state Tₚ based on the reward.

The method 1100 begins with LSR block 1104 presenting the user's last selected response (“LSR”). The LSR corresponds to a temperature state of the MLM when it generated the response selected by the user. In FIG. 10 it is labeled the “selected temperature” and in FIG. 11 it is labeled Tₛ based on that correspondence. The method compares Tₛ to the existing temperature Tₑ prior to the LSR. At this point in the method 1000, being the first pass through the RL model 1010, the LSR 1104 can be the SBR 1004 (FIG. 10). Block 1106 determines if the LSR block 1004 selected a high temperature value Tₛ over a low existing temperature value Tₑ. If so, then reward block 1108 can set the reward R to 1. For this first pass, Tₑ can be set to any desired reference value, such as but not limited to a grid temperature of 0.5. Similarly, block 1110 determines if the LSR block 1104 selected a low temperature value Tₛ over a high existing temperature value Tₑ, and if so then reward block 1112 can set the reward R to −1. Block 1114 determines if the LSR block 1104 selected a temperature value Tₛ that is equal to the existing temperature value Tₑ, and if so then reward block 1116 can set the reward R to 0.

A bias function block 1118 can apply the appropriate reward R block 1108, 1112, 1116 to incrementally adjust Tₛ. For example, without limitation, the reward can act as a weight function applied to a predetermined increment for adjusting Tₛ. That is, in this example, if the predetermined increment is 0.1, and the reward is 1, then the incremental adjustment to Tₛ can be 0.1. Conversely, if the reward is −1 then the incremental adjustment can be −0.1, and if the reward is 0 then the incremental adjustment can be 0. Block 1120 applies the bias function block 1118 to Tₛ to derive a predicted temperature Tₚ controlled by block 1122.

Returning to FIG. 10, policy block 1012 controls block 1014 in issuing an iterative prompt at each of two iterative temperature states, the predicted temperature state Tₚ and the selected temperature state Tₛ. Block 1016 sets the MLM is set to Tₛ, which at this point of the method is a temperature state corresponding to a temperature state of the SBR 1004. An iterative prompt is issued to the MLM at the iterative temperature state Tₛ. A first response is received from the MLM at the iterative temperature state Tₛ. Block 1018 sets the MLM to the predicted temperature state Tₚ. The iterative prompt is issued to the MLM at the predicted temperature state. A second response is received to the iterative prompt from the MLM at the predicted temperature state.

Block 1020 selects a selected iterative response (“SIR”) from the first and second responses to the iterative prompt. The selection can be made by a human user, or the selection can be automated with any desired logic. Control then passes to block 1022 which determines if the temperature state Tₛ corresponding to the SIR 1020 is satisfactory to the user.

Upon determining that the temperature state Tₛ is satisfactory, then block 1024 can set the MLM temperature to Tₛ for the prompt session. Block 1024 can also store Tₛ to a computer memory for later reference or recall, such as to apply Ts in a different prompt session and/or with a different MLM.

Conversely, upon block 1022 determining that the SIR 1020 is not satisfactory, then a counter 1026 increments the environment for a subsequent pass through the RL model 1010. Counter block 1026 can supply the SIR 1020 as an iterative action to the RL model 1010 in a feedback loop. In this subsequent pass and all other subsequent passes, the most recent SIR 1020 populates the LSR block 1104 in FIG. 11. Likewise, the temperature state Tₛ corresponding to most recent SIR 1020 populates the selected temperate block 1016 in FIG. 10. In other words, in this first subsequent pass the SIR 1020 replaces the SBR 1004, and in all subsequent passes the most recent SIR 1020 is employed. This provides iterative feedback for the RL model 1010 to continually recompute the reward in response to the most recent iterative action and to recompute the predicted temperature Tₚ based on the most recent recomputed reward.

In this first subsequent pass through the RL model 1010, policy block 1012 controls issuance of a subsequent iterative prompt in block 1014 at each of two subsequent iterative temperature states, a recomputed predicted temperature state Tₚ and a subsequent iterative temperature state corresponding to a temperature state of the most recent SIR 1020 Tₛ. Block 1016 sets the MLM to a subsequent iterative temperature state corresponding to a temperature state of the most recent SIR 1020. A subsequent iterative prompt can be issued to the MLM at the subsequent iterative temperature state Tₛ. A first response to the subsequent iterative prompt is received from the MLM at the subsequent iterative temperature state Tₛ. The MLM can then be set to the recomputed predicted temperature state Tₚ based on the SIR 1020 instead of the SBR 1004. The subsequent iterative prompt can be issued to the MLM at the recomputed predicted temperature state Tₚ. A second response to the subsequent iterative prompt is received from the MLM at the recomputed predicted temperature state Tₚ. SIR selects a subsequent SIR from the first and second responses to the subsequent iterative prompt. Block 1022 can then determine if the subsequent SIR 1022 is satisfactory to the user.

Upon determining that the subsequent SIR 1020 is satisfactory, then block 1024 can set the MLM temperature state to the most recent Tₛ temperature state corresponding to the satisfactory subsequent SIR 1020. At this point, the method 1000 has successfully optimized the temperature parameter for continuing with the prompt session with the MLM. Block 1024 can store the optimized temperature to a computer memory for later reference or use.

Conversely, upon determining that the most recent subsequent SIR 1020 is not satisfactory to the user, then the counter 1026 can be incremented again in the feedback loop supplying the SIR 1020 as an iterative action to the RL model 1010. By plugging the SIR 1020 into the LSR block 1104 of FIG. 11, the RL model 1010 can recompute the reward in response to the iterative action and recompute the predicted temperature Tₚ based on the most recent recomputed reward. This iterative method can be repeated as many times as necessary until it is determined that a most recent SIR 1020 is satisfactory to the user. At that point, the temperature state Tₛ corresponding to the most recent subsequent SIR 1020 can define the optimized temperature parameter for the MLM.

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings. The components, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Numerous other embodiments are also contemplated. These include embodiments that have fewer, additional, and/or different components, steps, features, objects, benefits, and advantages. These also include embodiments in which the components and/or steps are arranged and/or ordered differently.

Aspects of the present disclosure are described herein with reference to call flow illustrations and/or block diagrams of a method, apparatus (systems), and computer program products according to embodiments of the present disclosure. It will be understood that each step of the flowchart illustrations and/or block diagrams, and combinations of blocks in the call flow illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the call flow process and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the call flow and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

It is to be appreciated that the computer system (e.g., the specialized computer 101, the PSO engine 180, and/or the processing resources) performs acts involving quantile regression of heteroscedastic error distributions that cannot be performed by a human (e.g., is greater than the capability of a single human mind). For example, an amount of data processed, a speed of processing of data and/or data types of the data processed over a certain period of time can be greater, faster and different than an amount, speed and data type that can be processed by a single human mind over the same period of time. The computer system can also be fully operational towards performing one or more other functions while also performing the above-referenced signal processing functions. Moreover, signal processing output generated by computer system can include information that is impossible to obtain manually by a user. For example, an amount of information included in the signal processing output and/or a variety of information included in the signal processing output can be more complex than information obtained manually by a user.

Moreover, because at least the conditional conformal prediction intervals of this disclosure are established from a combination of electrical and mechanical components and circuitry, a human is unable to replicate or perform processing performed by the computer system (e.g., specialized computer 101, the PSO engine 180, resources) disclosed herein. For example, a human is unable to communicate data and/or process data associated with the PSO engine 180 for a given downstream task. Additionally, the specialized computer 101 significantly improves the operating efficiencies of the computer system by accurately and reliably eliminating detrimental signal amplitude instability and noise.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed:

1. A computer-implemented method for optimizing a prompt session with a machine learning model (“MLM”) trained on a training dataset, the computer-implemented method comprising:
setting the MLM to a first temperature state;
issuing a baseline prompt to the MLM at the first temperature state;
receiving a first response to the baseline prompt from the MLM at the first temperature state;
setting the MLM to a second temperature state;
issuing the baseline prompt to the MLM at the second temperature state;
receiving a second response to the baseline prompt from the MLM at the second temperature state;
selecting a selected baseline response (“SBR”) from the first and second responses to the baseline prompt; and
supplying the SBR as a baseline action to a reinforcement learning model (“RLM”) configured to:
compute a reward in response to the baseline action; and
compute a predicted temperature state based on the reward.

2. The computer-implemented method of claim 1, further comprising:
setting the MLM to an iterative temperature state corresponding to a temperature state of the SBR;
issuing an iterative prompt to the MLM at the iterative temperature state;
receiving a first response to the iterative prompt from the MLM at the iterative temperature state;
setting the MLM to the predicted temperature state;
issuing the iterative prompt to the MLM at the predicted temperature state;
receiving a second response to the iterative prompt from the MLM at the predicted temperature state;
selecting a selected iterative response (“SIR”) from the first and second responses to the iterative prompt; and
determining if the SIR is satisfactory.

3. The computer-implemented method of claim 2, further comprising:
upon determining that the SIR is satisfactory, setting the MLM to a temperature state corresponding to a temperature state of the SIR; and
upon determining that the SIR is not satisfactory, supplying the SIR as an iterative action to the RLM that is configured to:
recompute the reward in response to the iterative action; and
recompute the predicted temperature state based on the recomputed reward;

4. The computer-implemented method of claim 3, further comprising:
setting the MLM to a subsequent iterative temperature state corresponding to a temperature state of the SIR;
issuing a subsequent iterative prompt to the MLM at the subsequent iterative temperature state;
receiving a first response to the subsequent iterative prompt from the MLM at the subsequent iterative temperature state;
setting the MLM to the recomputed predicted temperature state;
issuing the subsequent iterative prompt to the MLM at the recomputed predicted temperature state;
receiving a second response to the subsequent iterative prompt from the MLM at the recomputed predicted temperature state;
selecting a subsequent SIR from the first and second responses to the subsequent iterative prompt;
determining if the subsequent SIR is satisfactory.

5. The computer-implemented method of claim 4, further comprising:
upon determining that the subsequent SIR is satisfactory, setting the MLM to a temperature state corresponding to a temperature state of the subsequent SIR; and
upon determining that the subsequent SIR is not satisfactory, supplying the subsequent SIR as a subsequent iterative action to the RLM that is configured to:
recompute the reward in response to the subsequent iterative action; and
recompute the predicted temperature state based on a most recent recomputed reward.

6. The computer-implemented method of claim 1, wherein the training dataset comprises a plurality of data vectors in an embedding space of the MLM.

7. The computer-implemented method of claim 4, wherein the baseline prompt, the iterative prompt, and the subsequent iterative prompt each comprise a search vector in an embedding space of the MLM.

8. The computer-implemented method of claim 7, wherein the iterative temperature state and the subsequent iterative temperature state each comprise a probability distribution around one of the search vectors in the embedding space of the MLM.

9. The computer-implemented method of claim 4, wherein:
the iterative temperature state comprises a probability distribution around the SBR; and
the subsequent iterative temperature state comprises a probability distribution around the SIR.

10. A computer program product for optimizing a prompt session with a machine learning model (“MLM”) that is trained on a set of training data, the computer program product comprising a computer readable storage medium having program instructions embodied therewith, the program instructions executable by a processor to cause a computing device to:
set the MLM to a first temperature state;
issue a baseline prompt to the MLM at the first temperature state;
receive a first response to the baseline prompt from the MLM at the first temperature state;
set the MLM to a second temperature state;
issue the baseline prompt to the MLM at the second temperature state;
receive a second response to the baseline prompt from the MLM at the second temperature state;
select a selected baseline response (“SBR”) from the first and second responses to the baseline prompt; and
supply the SBR as a baseline action to a reinforcement learning model (“RLM”) configured to:
compute a reward in response to the baseline action; and
compute a predicted temperature state based on the reward.

11. The computer program product of claim 10, wherein the program instructions executable by the processor further cause the computing device to:
set the MLM to an iterative temperature state corresponding to a temperature state of the SBR;
issue an iterative prompt to the MLM at the iterative temperature state;
receive a first response to the iterative prompt from the MLM at the iterative temperature state;
set the MLM to the predicted temperature state;
issue the iterative prompt to the MLM at the predicted temperature state;
receive a second response to the iterative prompt from the MLM at the predicted temperature state;
select a selected iterative response (“SIR”) from the first and second responses to the iterative prompt; and
determine if the SIR is satisfactory.

12. The computer program product of claim 11, wherein the program instructions executable by the processor further cause the computing device to:
upon determining that the SIR is satisfactory, set the MLM to a temperature state corresponding to a temperature state of the SIR; and
upon determining that the SIR is not satisfactory, supply the SIR as an iterative action to the RLM that is configured to:
recompute the reward in response to the iterative action; and
recompute the predicted temperature state based on the recomputed reward;

13. The computer program product of claim 12, wherein the program instructions executable by the processor further cause the computing device to:
set the MLM to a subsequent iterative temperature state corresponding to a temperature state of the SIR;
issue a subsequent iterative prompt to the MLM at the subsequent iterative temperature state;
receive a first response to the subsequent iterative prompt from the MLM at the subsequent iterative temperature state;
set the MLM to the recomputed predicted temperature state;
issue the subsequent iterative prompt to the MLM at the recomputed predicted temperature state;
receive a second response to the subsequent iterative prompt from the MLM at the recomputed predicted temperature state;
select a subsequent SIR from the first and second responses to the subsequent iterative prompt; and
determine if the subsequent SIR is satisfactory.

14. The computer program product of claim 13, wherein the program instructions executable by the processor further cause the computing device to:
upon determining that the subsequent SIR is satisfactory, set the MLM to a temperature state corresponding to a temperature state of the subsequent SIR; and
upon determining that the subsequent SIR is not satisfactory, supply the subsequent SIR as a subsequent iterative action to the RLM that is configured to:
recompute the reward in response to the subsequent iterative action; and
recompute the predicted temperature state based on a most recent recomputed reward.

15. The computer program product of claim 10, wherein the training data comprises a plurality of data vectors in an embedding space of the MLM.

16. The computer program product of claim 13, wherein the baseline prompt, the iterative prompt, and the subsequent iterative prompt each comprise a search vector in an embedding space of the MLM.

17. The computer program product of claim 16, wherein the iterative temperature state and the subsequent iterative temperature state each comprise a probability distribution around one of the search vectors in the embedding space of the MLM.

18. A computer system for optimizing a prompt session with a machine learning model (“MLM”) that is trained on a set of training data, the computer system having a processor, a computer-readable memory, a computer-readable tangible storage device, and program instructions stored on the storage device for execution by a processor via the computer-readable memory, wherein the execution of the program instructions causes the computer system to perform a method, comprising:
setting the MLM to a first temperature state;
issuing a baseline prompt to the MLM at the first temperature state;
receiving a first response to the baseline prompt from the MLM at the first temperature state;
setting the MLM to a second temperature state;
issuing the baseline prompt to the MLM at the second temperature state;
receiving a second response to the baseline prompt from the MLM at the second temperature state;
selecting a selected baseline response (“SBR”) from the first and second responses to the baseline prompt; and
supplying the SBR as a baseline action to a reinforcement learning model (“RLM”) configured to:
compute a reward in response to the baseline action; and
compute a predicted temperature state based on the reward.

19. The computer system of claim 18, wherein the method further comprises:
setting the MLM to an iterative temperature state corresponding to a temperature state of the SBR;
issuing an iterative prompt to the MLM at the iterative temperature state;
receiving a first response to the iterative prompt from the MLM at the iterative temperature state;
setting the MLM to the predicted temperature state;
issuing the iterative prompt to the MLM at the predicted temperature state;
receiving a second response to the iterative prompt from the MLM at the predicted temperature state;
selecting a selected iterative response (“SIR”) from the first and second responses to the iterative prompt; and
determining if the SIR is satisfactory.

20. The computer system of claim 19, wherein the method further comprises:
upon determining that the SIR is satisfactory, setting the MLM to a temperature state corresponding to a temperature state of the SIR; and
upon determining that the SIR is not satisfactory, supplying the SIR as an iterative action to the RLM that is configured to:
recompute the reward in response to the iterative action; and
recompute the predicted temperature state based on the recomputed reward;
setting the MLM to a subsequent iterative temperature state corresponding to a temperature state of the SIR;
issuing a subsequent iterative prompt to the MLM at the subsequent iterative temperature state;
receiving a first response to the subsequent iterative prompt from the MLM at the subsequent iterative temperature state;
setting the MLM to the recomputed predicted temperature state;
issuing the subsequent iterative prompt to the MLM at the recomputed predicted temperature state;
receiving a second response to the subsequent iterative prompt from the MLM at the recomputed predicted temperature state;
selecting a subsequent SIR from the first and second responses to the subsequent iterative prompt;
determining if the subsequent SIR is satisfactory;
upon determining that the subsequent SIR is satisfactory, setting the MLM to a temperature state corresponding to a temperature state of the subsequent SIR; and
upon determining that the subsequent SIR is not satisfactory, supplying the subsequent SIR as a subsequent iterative action to the RLM that is configured to:
recompute the reward in response to the subsequent iterative action; and
recompute the predicted temperature state based on a most recent recomputed reward.
